(19) United States
(12) Patent Application Publication
(10) Pub. No.: US 2013/0168962 A1
(43) Pub. Date: Jul. 4, 2013

(54) Vehicle Based Windmill Apparatus

(71) Applicant: Daniel B. Bruno, Lewes, DE (US)

(72) Inventor: Daniel B. Bruno, Lewes, DE (US)

(21) Appl. No.: 13/341,953

(22) Filed: Dec. 31, 2011

(51) Int. Cl. H02P 9/04

(52) U.S. Cl. 290/44

(57) ABSTRACT

The present invention generally relates to vehicle based power generation. Specifically, this invention relates to a vehicle based windmill apparatus capable of generating power via a wind turbine attached to an adjustable arm that raises and lowers out of a vehicle, depending on certain variables. The wind turbine can be utilized to generate power during deceleration by using wind force to turn the turbine, which in turn generates power while also having the secondary benefit of creating additional drag to help slow or stop the vehicle.

### FIELD OF THE INVENTION

The present invention generally relates to vehicle based power generation. Specifically, this invention relates to a vehicle based windmill apparatus capable of generating power via a wind turbine attached to an adjustable arm that raises and lowers out of a vehicle, depending on certain variables. The wind turbine can be utilized to generate power during deceleration by using wind force to turn the turbine, which in turn generates power while also having the secondary benefit of creating additional drag to help slow or stop the vehicle.

### BACKGROUND OF THE INVENTION

With the current push to cut down on carbon emissions and move to the use of vehicles that utilize completely electric powered motors or hybrid motors using both gas and electric power, there is a need for novel concepts related to transference of kinetic energy into stored or potential energy for future use. Currently, vehicles fail to capture a significant portion of energy lost during the deceleration of a vehicle.

Certain concepts, such as regenerative braking, have been explored and utilized with electric vehicles (EVs) and hybrid vehicles (HVs). However, while regenerative braking concepts have been utilized in order to capture some of the energy lost during deceleration, there still remains a vast amount of energy that is not recaptured during the deceleration process.

One major force that is almost always accessible while deceleration, wind resistance, is not currently utilized to generate electricity in EVs and HVs. Drag from wind resistance is an ever present force on all vehicles, yet vehicles have not been designed to capture this force in an appropriate manner, as most aspects of vehicle production are simply limited to reducing drag forces.

Therefore, there is a need in the art for a vehicle based windmill apparatus capable of converting drag forces or other wind resistant forces into electrical power while also assisting with the deceleration process of a vehicle. These and other features and advantages of the present invention will be explained and will become obvious to one skilled in the art through the summary of the invention that follows.

### SUMMARY OF THE INVENTION

Accordingly, it is an object of the present invention to provide a windmill apparatus configured to be installed in a vehicle that generates power while assisting in the deceleration of the vehicle. The windmill apparatus is further configured to raise and lower in and out of the vehicle depending on whether the vehicle is maintaining speed, accelerating or decelerating.

According to an embodiment of the present invention, the windmill apparatus is comprised of one or more actuating arms, one or more lift systems and one or more wind turbines. Optionally, the windmill apparatus may further comprise a mounting and/or stabilization base, a power converter and a connection to a vehicle power system.

According to an embodiment of the present invention, the one or more actuating arms may be configured, in conjunction with the one or more lift systems, to raise and lower the windmill apparatus out of or into the vehicle, depending on whether the vehicle is maintaining speed, accelerating or decelerating.

According to an embodiment of the present invention, the one or more wind turbines are configured to harness the wind forces passing around the vehicle to turn fan blades within or upon the wind turbines in order to generate electrical power. Further, resistance created by the wind force crossing the wind turbines works to further enhance the deceleration of the vehicle.

According to an embodiment of the present invention, the optional mounting and/or stabilization base is configured to mount and retain the windmill apparatus within the vehicle in such a manner that the apparatus is resilient to the repeated forces applied to it through normal operation. The mounting and/or stabilization base may be further configured to allow easy mounting in standard vehicles as to allow modification of standard vehicles to be retrofit with windmill apparatuses in accordance with the present invention.

According to an embodiment of the present invention, the optional power converter is configured to provide a pathway for the electrical power generated through use of the apparatus into the electrical system of the vehicle.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 illustrates a perspective view of an embodiment of the present invention, in accordance with an embodiment of the present invention;

FIG. 2 illustrates a top view of an embodiment of the present invention, in accordance with an embodiment of the present invention;

FIG. 3 illustrates a perspective view of an embodiment of the present invention, in accordance with an embodiment of the present invention;

FIG. 4 illustrates a top view of an embodiment of the present invention, in accordance with an embodiment of the present invention;

FIG. 5 illustrates a perspective view of an embodiment of the present invention, in accordance with an embodiment of the present invention;

FIG. 6 illustrates a perspective view of an embodiment of the present invention, in accordance with an embodiment of the present invention;

FIG. 7 illustrates a perspective view of an embodiment of the present invention, in accordance with an embodiment of the present invention;

FIG. 8 illustrates a perspective view of an embodiment of the present invention, in accordance with an embodiment of the present invention;

FIG. 9 illustrates a front perspective view of an embodiment of the present invention, in accordance with an embodiment of the present invention;

FIG. 10 illustrates a front perspective view of an embodiment of the present invention, in accordance with an embodiment of the present invention;

FIG. 11 illustrates a detailed top view of an embodiment of the present invention, in accordance with an embodiment of the present invention;

FIG. 12 illustrates a detailed bottom view of an embodiment of the present invention, in accordance with an embodiment of the present invention;

FIG. 13 illustrates a perspective view of an embodiment of the present invention, in accordance with an embodiment of the present invention;

FIG. 14 illustrates a perspective view of an embodiment of the present invention, in accordance with an embodiment of the present invention;

FIG. 15 illustrates a rear perspective view of an embodiment of the present invention, in accordance with an embodiment of the present invention;

FIG. 16 illustrates a rear perspective view of an embodiment of the present invention, in accordance with an embodiment of the present invention;

FIG. 17 illustrates a side view of an embodiment of the present invention, in accordance with an embodiment of the present invention;

FIG. 18 illustrates a side view of an embodiment of the present invention, in accordance with an embodiment of the present invention;

FIG. 19 illustrates a top view of an embodiment of the present invention, in accordance with an embodiment of the present invention;

FIG. 20 illustrates a perspective view of a turbine component, in accordance with an embodiment of the present invention;

FIG. 21 illustrates a front view of an embodiment of the present invention, in accordance with an embodiment of the present invention;

FIG. 22 illustrates a perspective view of a fan component, in accordance with an embodiment of the present invention;

FIG. 23 illustrates a side view of an embodiment of the present invention, in accordance with an embodiment of the present invention;

FIG. 24 illustrates a side view of an embodiment of the present invention, in accordance with an embodiment of the present invention; and

FIG. 25 illustrates a side view of an embodiment of the present invention, in accordance with an embodiment of the present invention.

### DETAILED SPECIFICATION

The present invention generally relates to vehicle based power generation. Specifically, this invention relates to a vehicle based windmill apparatus capable of generating power via a wind turbine attached to an adjustable arm that raises and lowers out of a vehicle, depending on certain variables. The wind turbine can be utilized to generate power during deceleration by using wind force to turn the turbine, which in turn generates power while also having the secondary benefit of creating additional drag to help slow or stop the vehicle.

Accordingly, it is an object of the present invention to provide a windmill apparatus configured to be installed in a vehicle that generates power while assisting in the deceleration of the vehicle. The windmill apparatus is further configured to raise and lower in and out of the vehicle depending on whether the vehicle is maintaining speed, accelerating or decelerating.

According to an embodiment of the present invention, the windmill apparatus is comprised of one or more actuating arms, one or more lift systems and one or more wind turbines. Optionally, the windmill apparatus may further comprise a mounting and/or stabilization base, a power converter and a connection to a vehicle power system.

According to an embodiment of the present invention, the one or more actuating arms Are configured, in conjunction with the one or more lift systems, to raise and lower the windmill apparatus out of or into the vehicle, depending on whether the vehicle is maintaining speed, accelerating or decelerating. In a preferred embodiment, two actuating arms are utilized and connected to either side of the windmill apparatus. The actuating arms are driven by one or more lift systems in order to be raised and lowered from a vehicle into the air stream outside of the moving vehicle.

The lift system may be any manner of lift system that is capable of raising the actuating arms in light of forces applied to the apparatus as it is raising. Lift systems may include, but are not limited to, electromagnetic lift systems, pneumatic lift systems, hydraulic lift systems or any combination thereof. In a preferred embodiment, the lift systems are hydraulic lift systems capable of raising the operating portion (e.g., the wind turbines and actuating arms) of the windmill apparatus out of the vehicle against substantial downward wind force.

According to an embodiment of the present invention, the actuating arms may be configured to lock into place once fully extended. In this manner, the lift system need only to apply enough force to initially raise the apparatus against the downward wind forces as the apparatus will lock into place once fully extended. The raised position is known as the operating position and the lowered position (i.e., when the apparatus is fully retained in the vehicle) is known as the resting position.

According to an embodiment of the present invention, the apparatus may be controlled by an electronic or manual control means. The control means is configured to extend and retract the apparatus based on one or more characteristics ascertained by the control means. For instance, in a preferred embodiment, the control means is configured to identify when the vehicle is making a significant reduction in speed. In this situation, the control means will execute the extension of the apparatus into operating position. Other situations when a control means may execute the extension of the apparatus into operating position include, but are not limited to, decent down a grade where no press on the accelerator is detected, decent down a hill where braking is detected, moderate to heavy braking detected and when the emergency brake is applied.

Similarly, there are multiple situations in which the control means may execute the retraction of the apparatus into the resting position. For instance, the control means may affect the retraction of the apparatus upon detection of acceleration and release of the brake pedal. One of ordinary skill in the art would appreciate that there are numerous situations whereby the control means could be configured to identify criteria and affect the retraction or extension of the apparatus, and embodiments of the present invention are contemplated for control means with the ability to identify criteria and affect the retraction and/or extension of the apparatus. In a preferred embodiment, the control means is comprised of a computing element or device configured to detect certain criteria based on one or more sensors attached to or associated with the vehicle. The computing element of the control means may be incorporated within or in conjunction with other computing elements associated with the vehicle.

According to an embodiment of the present invention, the one or more wind turbines are connected to the one or more actuating arms and, when in the operating position, are configured to harness the wind forces passing around the vehicle to turn fan blades within or upon the wind turbines in order to generate electrical power. One of ordinary skill in the art would appreciate that there are numerous types of wind turbines that may be utilized with embodiments of the present invention, and embodiments of the present invention are contemplated for use with any type of wind turbine.

The apparatus is further configured to utilize resistance created by the wind force crossing the wind turbines to enhance the deceleration of the vehicle. The turning of the wind turbines creates additional drag that works to decelerate the vehicle while power is being generated. In certain embodiments, the wind turbines may be angled in such a way as to create appropriate forces to assist with this feature. For example, the front end of the wind turbines may be angled slightly down with the rear facing slightly up to create additional downward force on the rear end of the vehicle. In this manner, the wind forces may be utilized not only to decelerate the vehicle, but to add additional downward forces on the rear of the car to improve stability and control when decelerating from high speeds or down steep grades.

in a preferred embodiment, two large wind turbines are utilized, situated side by side and configured to be raised by two actuating arms out of the back quadrant of a vehicle. In alternate embodiments, any number of turbines may be utilized and may be configured to extend and retract from any quadrant of the vehicle.

According to an embodiment of the present invention, an optional mounting and/or stabilization base is utilized to mount and retain the windmill apparatus within the vehicle in such a manner that the apparatus is resilient to the repeated forces applied to it through normal operation. The mounting and/or stabilization base may be further configured to allow easy mounting in standard vehicles as to allow modification of standard vehicles to be retrofit with windmill apparatuses in accordance with the present invention. For instance, in a mini-van with a removable rear bench, the mounting base may be configured to utilize the existing mounting hardware for the rear bench to attach to. Depending on the size and number of wind turbines, further reinforcement may be needed on passenger vehicles.

In certain embodiments, the mounting and/or stabilization base may be permanently affixed to the vehicle. For instance the mounting and/or stabilization base may be welded, riveted or otherwise attached to the frame or floor of the vehicle. In alternate embodiments, the mounting and/or stabilization base may be removably affixed to the vehicle.

According to an embodiment of the present invention, a power converter is utilized to provide a pathway for the electrical power generated through use of the apparatus into the electrical system of the vehicle. In certain embodiments, wiring may be pre-configured with the vehicle and be run along the floor of the vehicle or in channels on the undercarriage of the vehicle. One of ordinary skill in the art would appreciate that there are numerous types of power converters that could be utilized with embodiments of the present invention, and embodiments of the present invention are contemplated for use with any type of power converter.

### EXEMPLARY EMBODIMENTS

### Figure Numbering

1—Vehicle
2—Sliding Roof
3—Windmill Apparatus
4—Driver's Seat
5—Brake Pedal
6—Power Booster
7—Reservoir
8—Main Cylinder
9—Main Pipe
10—Pipe to Front Brakes
11—Pipe to Propeller Unit & Rear Brakes
12—Pipe to Rear Brakes
13—actuating arm
14—Mounting and/or Stabilization Base
15—Volute Spring
16—Fan & Generator Assembly
17—Bearing
18—Bearing Nut
19—Cam Shaft
20—Cylinder
21—Clevis Mount
22—Clevis Pin
23—Cylinder Base Mount
24—Cylinder Piston
25—Fan Cover
26—Fan & Generator
27—Fan
28—Generator
29—Support

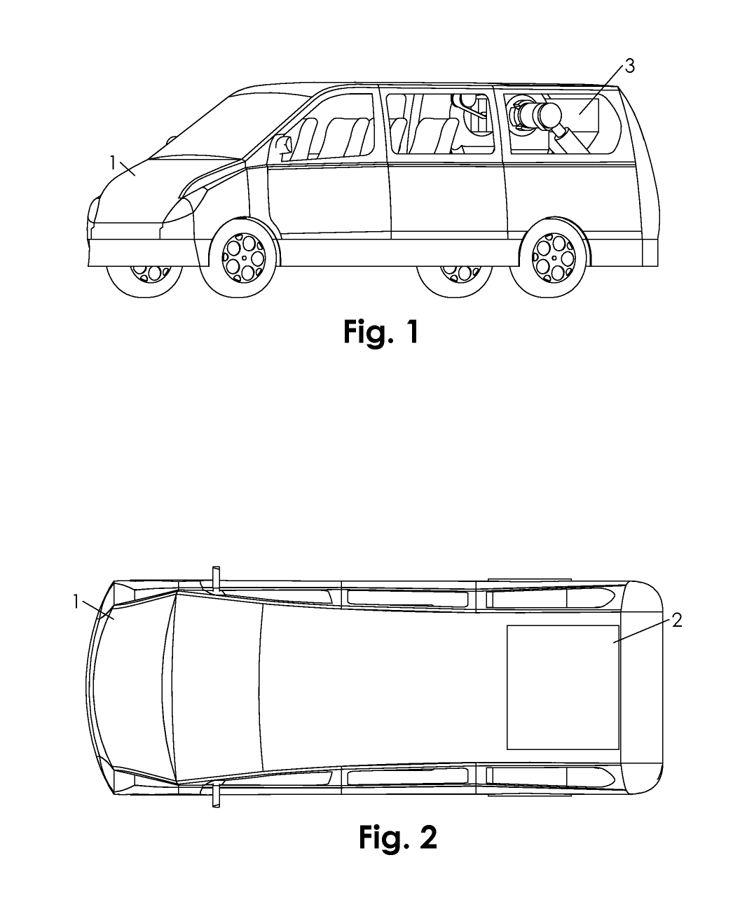

Turning now to FIG. 1, a perspective view of an embodiment of the present invention, in accordance with an embodiment of the present invention, is shown. In this embodiment, a vehicle 1 is shown with a windmill apparatus 3 installed in the rear quadrant of the vehicle 1.

Turning now to FIG. 2, a top view of an embodiment of the present invention, in accordance with an embodiment of the present invention, is shown. In this embodiment, a sliding roof is utilized to cover the windmill apparatus while in the lowered position. The sliding roof 2 mates with the roof of the vehicle 1, not unlike a sunroof or moon roof, in that while in the closed position, the sliding roof 2 is flush (or substantially flush) with the roof of the vehicle 1. This reduces or eliminates any drag that would otherwise be created.

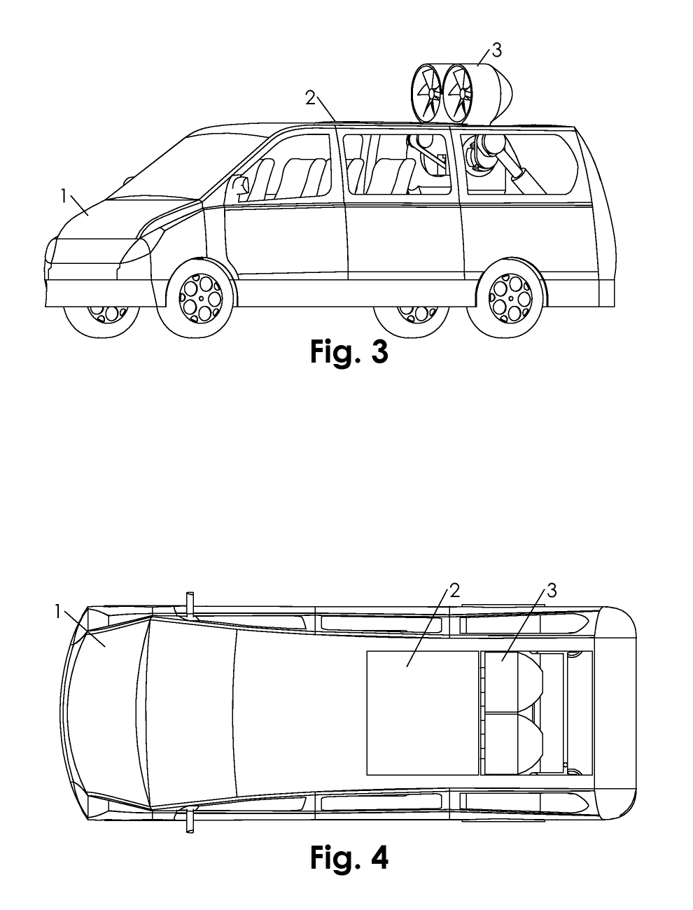

Turning now to FIG. 3, a perspective view of an embodiment of the present invention, in accordance with an embodiment of the present invention, is shown. In this embodiment, the windmill apparatus 3 is shown in the operating position, with the wind turbines fully extended above the vehicle 1. The sliding roof 2 is in an open position.

Turning now to FIG. 4, a top view of an embodiment of the present invention, in accordance with an embodiment of the present invention, is shown. In this embodiment, as in FIG. 3, the windmill apparatus 3 is fully extended into the operating position, with the sliding roof 2 in the open position.

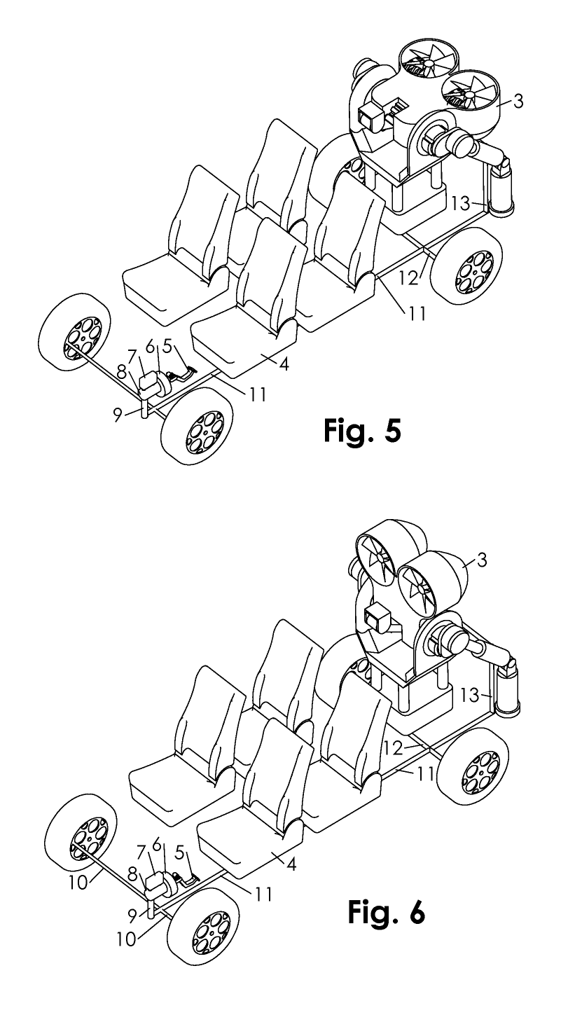

Turning now to FIG. 5, a perspective view of an embodiment of the present invention, in accordance with an embodiment of the present invention, is shown. In this embodiment, the windmill apparatus 3 is in the lowered position. Actuating arm 13 is shown and is configured to assist with the raising and lowering of the windmill apparatus 3 from the operating position to the lowered position. In certain embodiments, a pipe to rear brakes 12 may be present in order to effect certain functions of the control means. Further, a pipe 11 extending from the windmill apparatus 3 to the control unit for the brakes (comprising main pipe 9, main cylinder 8, reservoir 7, power booster 6, and brake pedal 5) may be utilized with certain control means functions. One of ordinary skill in the art would appreciate that while the term pipe is utilized in this application, no requirement for an actual pipe is present. The pipe may simply consist of a pathway of cables or other lines capable of transmitting power or data from one element to another.

Turning now to FIG. 6, a perspective view of an embodiment of the present invention, in accordance with an embodiment of the present invention, is shown. FIG. 6 shows the same embodiment as FIG. 5 above, save for the windmill apparatus 3 being in the operating position as opposed to the lowered position of FIG. 5.

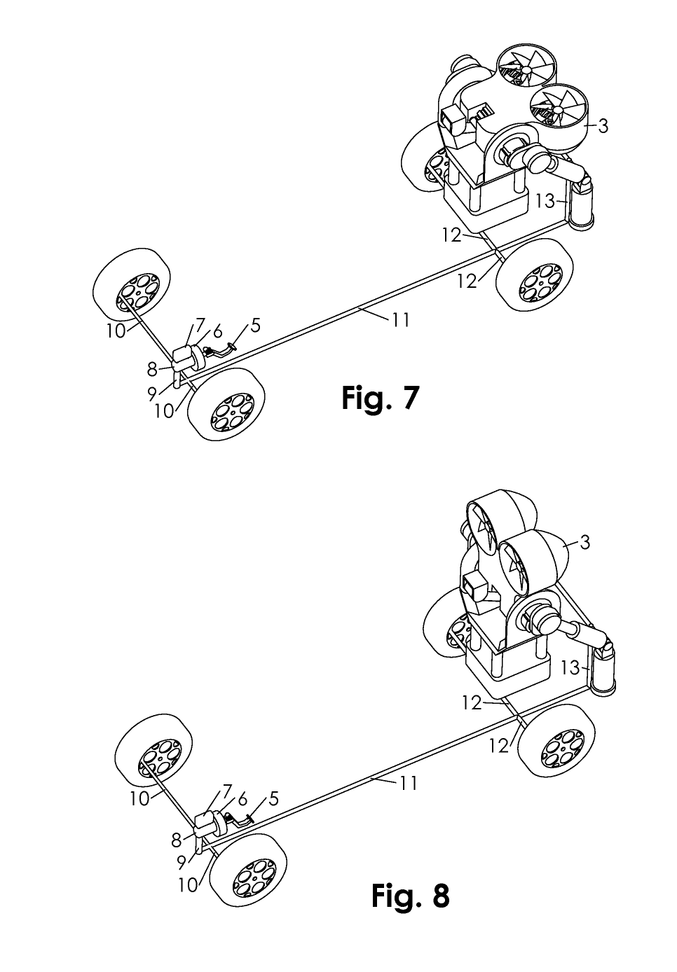

Turning now to FIGS. 7-8, perspective views of an embodiment of the present invention, in accordance with an embodiment of the present invention, are shown. In this embodiment, the integration of the windmill apparatus 3 can be clearly seen, with the windmill apparatus 3 being fully incorporated to work in conjunction with the braking system of the vehicle 1. FIG. 7 shows the windmill apparatus 3 in a lowered position, while FIG. 8 shows the windmill apparatus 3 in the operating position.

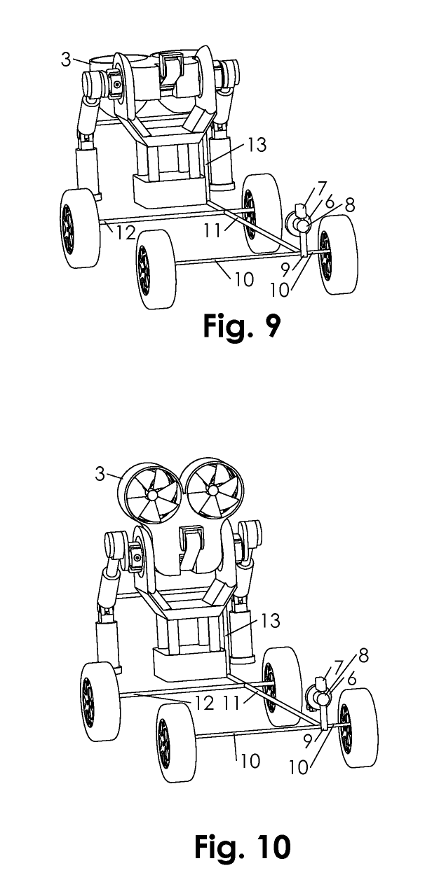

Turning now to FIGS. 9-10, front views of an embodiment of the present invention, in accordance with an embodiment of the present invention, are shown. In this embodiment, the integration of the windmill apparatus 3 can be clearly seen, with the windmill apparatus 3 being fully incorporated to work in conjunction with the braking system of the vehicle 1. FIG. 7 shows the windmill apparatus 3 in a lowered position, while FIG. 8 shows the windmill apparatus 3 in the operating position.

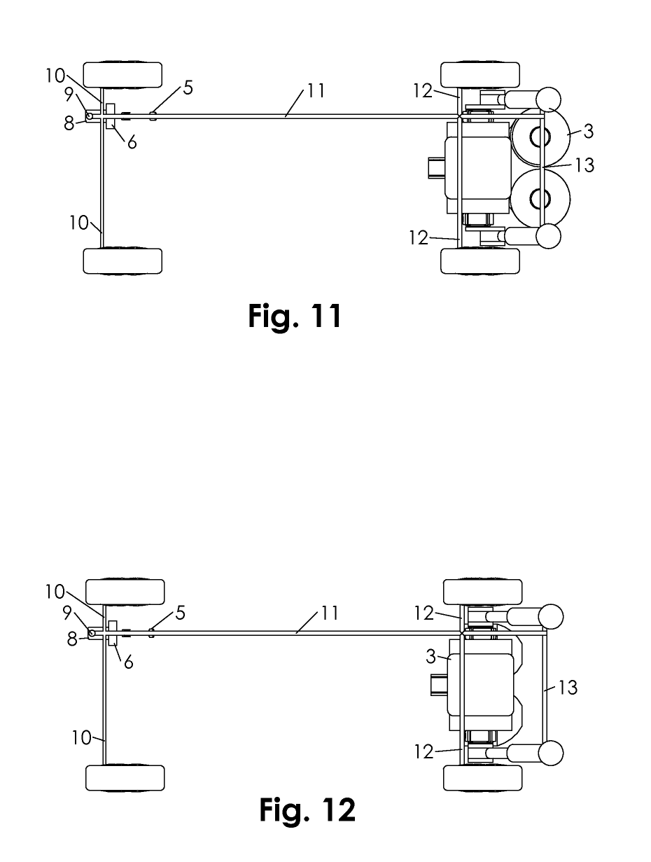

Turning now to FIGS. 11-12, detailed top views of an embodiment of the present invention, in accordance with an embodiment of the present invention, are shown. FIG. 11 shows the windmill apparatus 3 is shown in the lowered position, while FIG. 12 shows the windmill apparatus 3 in the operating position. As in FIGS. 9-10 above, the windmill apparatus 3 is fully incorporated to work in conjunction with the braking system of the vehicle 1.

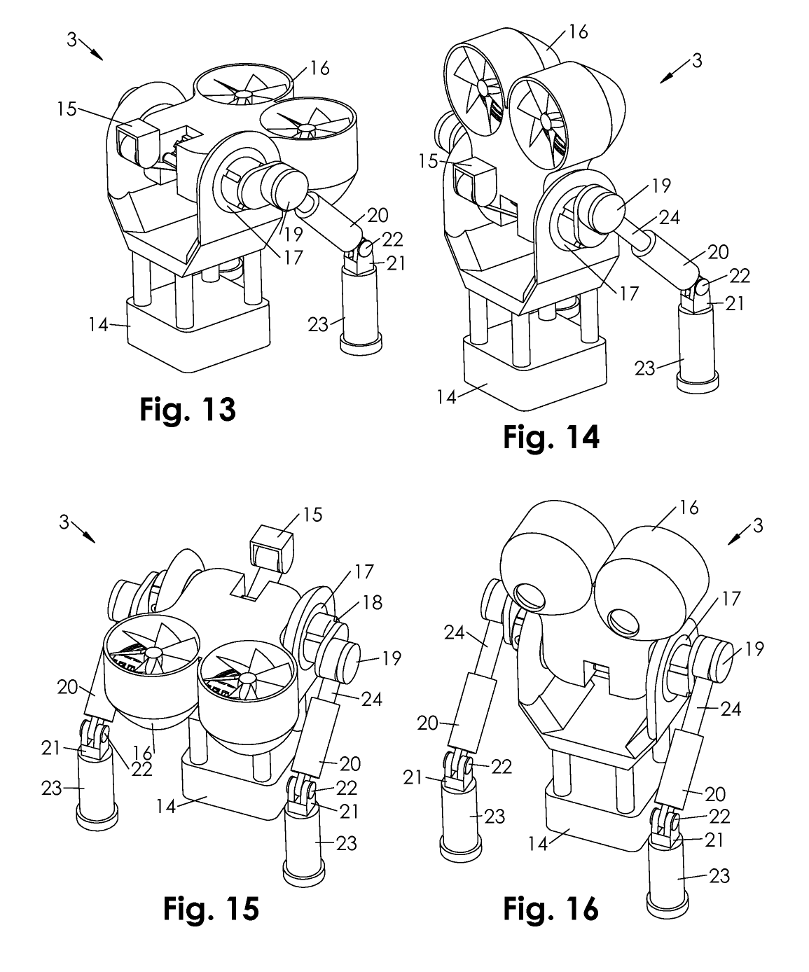

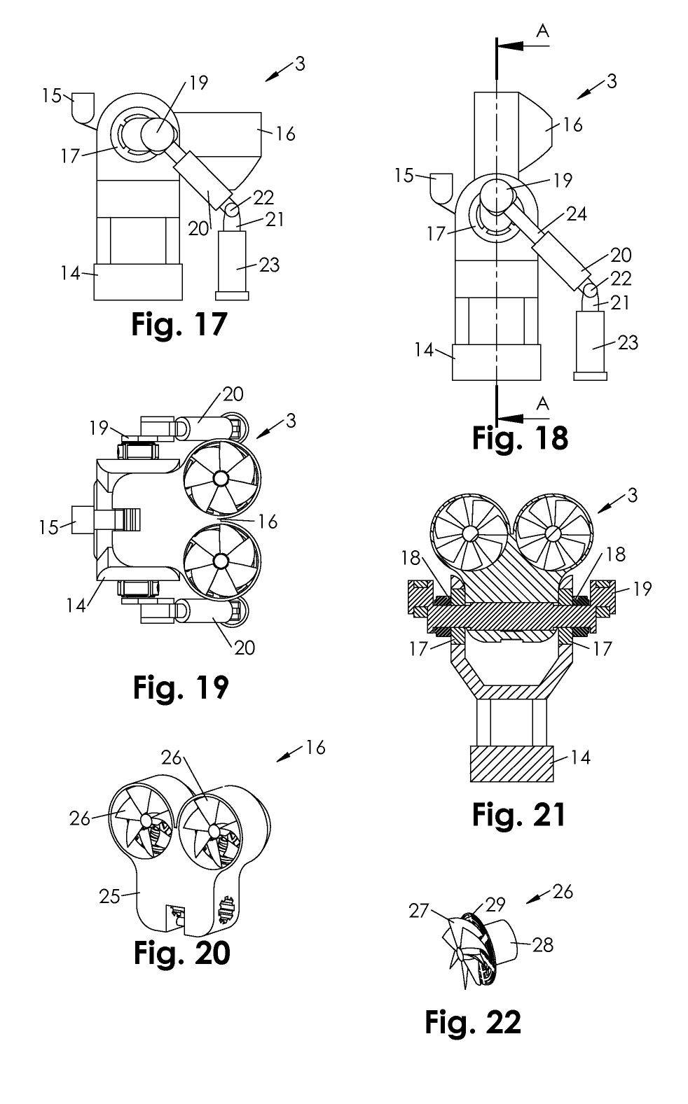

Turning now to FIGS. 13-21, multiple views of an embodiment of the present invention, in accordance with an embodiment of the present invention, are shown. In these FIGS., a windmill apparatus 3 is shown, incorporating a propeller base structure 14, cylinder base mounts 23, clevis mount 21, clevis pin 22, cylinder 20 and cam shaft 19 to functioning as the mounting and/or stabilization base for the apparatus. The windmill apparatus 3 is further comprised of a volute spring 15 and two bearings 17, acting as the actuating arm, configured to raise and lower the apparatus between the operating position and the lowered position. The volute spring 15 further acts as the lift system for the apparatus.

Turning now to FIG. 22, a perspective view of a fan component, in accordance with an embodiment of the present invention, is shown. The fan component (i.e., is incorporated within the wind turbine unit (i.e., fan & generator assembly 16). The fan component (i.e., fan and generator 26) comprises a fan 27, a generator 28, a support 29. As wind blows through the fan 27, the fan is turned, generating electrical power at generator 28. One of ordinary skill in the art would appreciate that there are numerous variations on wind turbine units that may be utilized with embodiments of the present invention, and embodiments of the present invention are contemplated for use with any wind turbine unit.

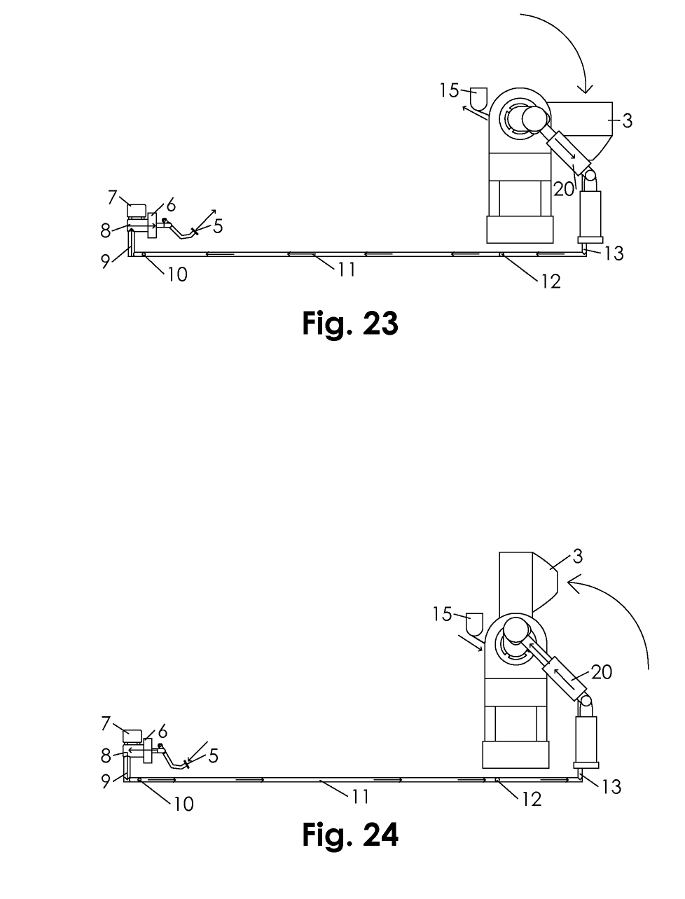

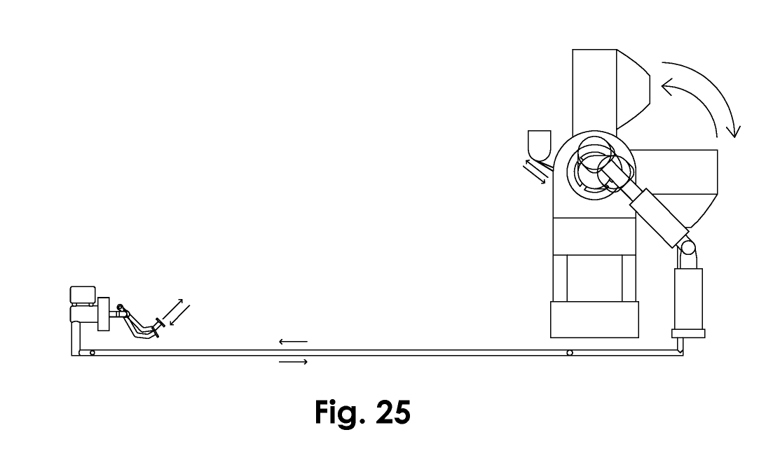

Turning now to FIGS. 23-25, views of an embodiment of the present invention, in accordance with an embodiment of the present invention, are shown. In these figures, the direction of motion executed between the operating position and lowered position is shown. In a preferred embodiment, the windmill apparatus 3 is raised from the lowered position into the operating position on a natural arc executed by the actuating arm and lift system. In alternate embodiments any motion may be utilized to affect the movement of the windmill apparatus 3 from the lowered position to the operating position and back.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A windmill apparatus for use in a vehicle, said windmill apparatus comprising:
one or more actuating arms configured to allow said windmill apparatus between a lowered position and an operating position;
one or more lift systems connected to said one or more actuating arms and configured to work in conjunction with said actuating arms to move said windmill apparatus between said lowered position and said operating position;
one or more wind turbines, wherein said one or more wind turbines are configured to generate electrical power when in said operating position; and
a control means configured to initiate movement of windmill apparatus between said operating position and said lowered position.

2. The windmill apparatus of claim 1, further comprising a power converter.

3. The windmill apparatus of claim 2, wherein said power converter is configured to receive electrical power from said windmill apparatus and provide said electrical power to a vehicle power system.

4. The windmill apparatus of claim 1, further comprising a mounting base.

5. The windmill apparatus of claim 4, wherein said mounting base is attached to said one or more actuating arms and is configured to attach said windmill apparatus to said vehicle.

6. The windmill apparatus of claim 5, wherein said mounting base is removably connected to said vehicle.

7. The windmill apparatus of claim 1, wherein said lift system is a hydraulic lift system.

8. The windmill apparatus of claim 1, wherein said lift system is a pneumatic lift system.

9. The windmill apparatus of claim 1, wherein said lift system is an electric lift system.

10. The windmill apparatus of claim 1, further comprising a sliding roof.

11. The windmill apparatus of claim 10, wherein said sliding roof is configured to move between a closed position when the windmill apparatus is in said lowered position to an open position when the windmill apparatus is in said operating position.

12. The windmill apparatus of claim 1, wherein said lift system is a hydraulic lift system.

13. The windmill apparatus of claim 1, wherein said control means is a manual control means.

14. The windmill apparatus of claim 1, wherein said control means is comprised of a computing element configured to automatically detect criteria related to said vehicle.

15. The windmill apparatus of claim 14, wherein said criteria are detected through the use of one or more sensors.

16. The windmill apparatus of claim 15, wherein said one or more sensors are connected to said vehicle.
